(19) United States
(12) Patent Application Publication
(10) Pub. No.: US 2006/0127200 A1
(43) Pub. Date: Jun. 15, 2006

(54) Fastening device

(76) Inventor: Franz Heiss, Loosdorf (AT)

Correspondence Address: ECKERT SEAMANS CHERIN & MELLOTT, 600 GRANT STREET, 44TH FLOOR, PITTSBURGH, PA, 15219, US

(21) Appl. No.: 10/560,551

(22) PCT Filed: Jun. 16, 2004
(86) PCT No.: PCT/EP04/51130

§ 371 Date: Dec. 12, 2005

(30) Foreign Application Priority Data
Jun. 16, 2003 (AT) GM41/2003

(51) Int. Cl. F16B 19/00

(52) U.S. Cl. 411/510

(57) ABSTRACT

A fastening device comprises a conical anchor piece (7, 17) and a conical recess (2) and, if necessary, an insertion piece (3). The conical outer surfaces (4, 10, 18) have annular grooves (5) on the one hand, and annular grooves (11) with O-rings or annular beads (19) on the other. The annular grooves (5) are somewhat offset in the height thereof with regard to the opposite annular grooves (11) or annular beads (9) so that in one anchor piece (7, 17), which rests with a stop, e.g. a flange (9, 20), a drawing force (14) serves to pretension. This results in the provision of self-tightening fastening device.

### FIELD OF THE INVENTION

The invention relates to a fastening device for the non-positive positioning of an anchor piece formed with a depth stop such as a flange or yoke in a recess or on an insertion piece located in the recess, comprising at least one O-ring in an open annular groove or at least one annular ring on the one hand and at least one recess, e.g. in the form of an annular groove, for receiving the O-ring or annular ring on the other in either the curved surface of the anchor piece or the curved surface of the recess.

Anchor pieces mean here component parts which can be embedded in the recess, which close the recess and which support connecting pieces such as hinge pieces or connection pieces, e.g. in the field of joinery, if required. Fastening will be by plugging in and is intended to provide for a secure hold. The anchor piece may also be a cap and the recess may also be an opening of a container. Primarily, cup plates for hinges are conceived of, in which nowadays the hinge cup is fastened with two screws in the recess, e.g. of a cabinet carcass.

Frictional connections are well-known. In this sense, anchor pieces in the form of plugs provided with radially protruding annular blades on the outside of the curved surface also belong to the prior art. These blades bear against the bore wall and they effect a sealing on the one hand and counteract the extraction forces on the other. Therefore, such plugs or anchor pieces are very easy to plug into the recess but they can only be removed with a major expenditure of force.

### DISCLOSURE OF THE INVENTION

### Technical Problem

It is the object of the invention to provide a fastening device as a plug-in connection according to the type described in the introduction which is not only suited for caps but is also suited for the secure anchoring of component parts to each other and which is only inserted into the recess and securely holds nevertheless.

### Technical Solution

This object is achieved by the facts that the curved surfaces are conical surfaces whose cone angles are in substantial agreement and the annular groove with which an opposite O-ring or annular ring engages is located at a lower level in the axial direction than the O-ring or annular ring of the anchor piece resting on the stop, e.g. the flange. Due to the conical surfaces which can be pushed into each other, a frictional contact occurs only shortly before the form and non-positive closures are reached. However, this does not only act as a snap-in locking connection but releases a force component which pulls the anchor piece into the recess until the flange or yoke of the anchor piece rests on an opposite surface, e.g. next to the edge of the recess. The dimensions and distances are matched with each other such that a residual force continues to exist and ensures the firm connection when the ring rests on the stop. Depending on the selection of the radial distances of the curved surfaces to each other and of the diameter of the O-ring or annular ring, the fastening device may result in a detachable or almost non-detachable connection.

A particularly useful embodiment is characterised in that adjacent open concentric annular grooves are provided on the curved surfaces of the anchor piece and in the recess which, when the anchor piece has been inserted into the recess until it reaches the stop, are opposite to each other in such a way that they are axially offset from each other and are adjacent to each other with a clearance, the O-rings or annular rings penetrating into the diagonally opposite annular grooves, while being elastically deformed, and releasing a force component in the sense of a pressure against the stop. This increases the effect of self-stressing of the fastening device.

A further improvement can be achieved by the facts that the radii of the channels of the annular grooves of the anchor piece increase for respectively larger annular groove diameters from one annular groove to the other and that the O-rings also comprise increasingly larger circular cross-sections.

Another embodiment is characterised in that the anchor piece carries an O-ring in each of the open annular grooves provided in the conical curved surface of the anchor piece, except for the annular groove having the largest diameter, and that ribs protruding in the recess between the open annular grooves engage between the O-rings of the anchor piece and, when the anchor piece is pressed in, force the O-rings into the annular groove having the respectively next larger diameter, in which position they non-positively and positively engage with the annular grooves of the recess which are arranged at a respectively slightly lower level. The jumping of the O-rings releases forces which pull the anchor piece into the recess. These forces continue to act when the depth stop is reached. This requires that the elements of the fastening device, in their relative position to each other, have not yet reached, from a stable initial position of the O-rings, the neutral end position with respect to the annular groove into which the O-ring snaps. The O-ring or the O-rings or the elastic annular ring thus attempts to completely engage with the opposite annular groove but it is prevented from reaching this force-neutral condition by the stop.

The arrangement of the annular grooves, O-rings and annular ring(s) is, in a technical reversal, of course also possible on the other respective element (anchor piece or recess).

### BRIEF DESCRIPTION OF THE DRAWINGS

Embodiments of the subject matter of the invention are shown in the drawings.

FIG. 1 shows the cross-section of an anchor piece before it is inserted into a recess,

FIG. 2 shows the component parts according to FIG. 1 when they are being inserted,

FIG. 3 shows the component parts according to FIG. 1 in the fastening position,

FIG. 4 shows another anchor piece outside a recess,

FIG. 5 shows the anchor piece according to FIG. 4 in the fastening position, and

FIG. 6 shows a general view for the understanding of the inventive conception.

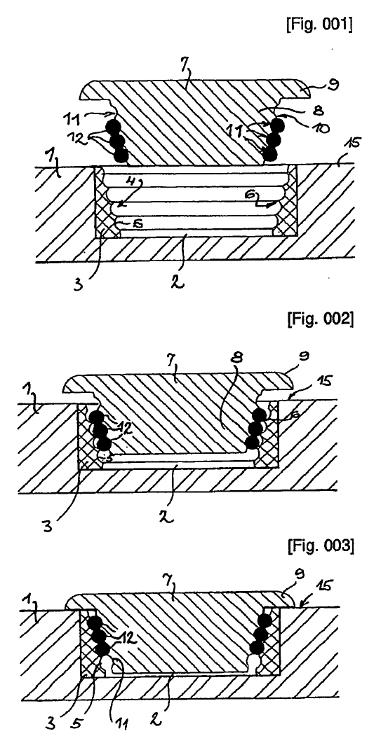

According to FIG. 1, in a wood plate 1, a recess 2 is provided in the form of a circular cylindrical milled-out portion in which an insertion piece 3 is permanently inserted. The insertion piece 3 comprises an inner curved surface 4 in the form of a circular cone in which open annular grooves 5 are arranged. The transition from annular groove 5 to annular groove may be formed as a sharp-edged or rounded rib 6.

An anchor piece 7 which may be made of plastic like the insertion piece 3 is opposite the recess 2. The anchor piece 7 comprises a conical portion 8 and a flange 9. E.g. four annular grooves 11 are provided in the conical curved surface 10 of the conical portion 8, an O-ring 12 being inserted in each of the three lower annular grooves 11. In FIG. 1, the topmost of the annular grooves 11 carries no O-ring.

The geometry of the flange 9 formed as a stop and the position of the annular grooves 5 and 11 with respect to the flange 9 and to each other are shown in the schematic FIG. 6. It appears from FIG. 6 that, when the anchor piece 7 has been inserted, the annular grooves 5 and 11 are not opposite to each other in such a way as is shown by the dashed line 13 but that the annular grooves 5 and 11 are offset from each other. That is, the annular grooves 5 and 11 are not on a common circle. This causes the O-rings 12 to take a stressed position in the annular grooves 5 and 11 offset from each other, namely in such a way that the flange 9 of the anchor piece 7 is pressed against the bearing surface 15 next to the recess 2 in the sense of the arrow 14. If the O-ring 12 in FIG. 6 is in the lower annular groove 11 before the anchor piece 7 is inserted into the recess 2, the O-ring 12 will push against the rib 6 and will be rolled into the upper annular groove 11. This reaction force also presses the anchor piece 7 into the recess 2.

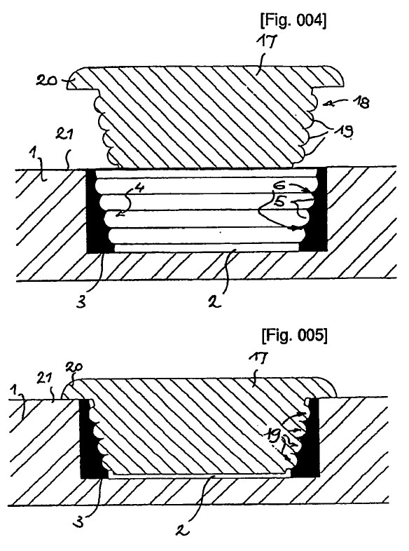

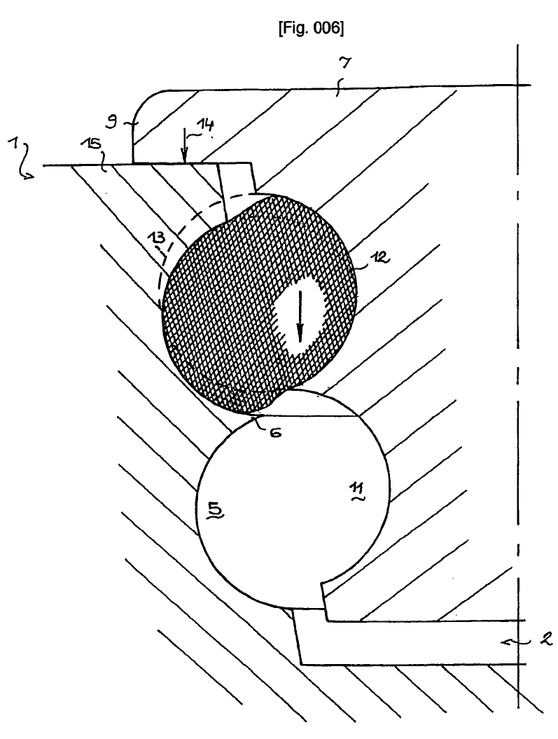

According to FIGS. 1 to 3, this process will be further improved by the fact that during the insertion of the anchor piece 7 (FIG. 2), the ribs 6 roll the O-rings 12 upward by one annular groove 11 at a time so that a position according to FIG. 3 is finally achieved. This rotation (torsion) prestresses the O-rings 12 such that they pull the anchor piece 7 into the recess 2. This force continues to exist, as the flange 9 already rests on the bearing surface 15 and prevents the anchor piece 7 from further penetrating before a stress-relieved condition (that is, for example, a complete revolution) is reached. The anchor piece 7 is thus held inside the recess, so to speak, in a self-stressing manner (FIG. 3). In addition to that, there is the effect caused by the annular grooves 5 and 11 offset from each other as is clearly shown in FIG. 6. This applies a holding force. In FIGS. 4 and 5, in the wood plate 1, a recess 2 having the insertion piece 3 and the annular grooves 5 with lands 6 is again provided in the conical curved surface 4. However, the anchor piece 17 comprises on the conical curved surface 18 thereof a plurality of annular rings 19 whose outer surfaces approximately correspond to the envelope of the O-rings 12 according to FIGS. 1 to 3. These remain stationary and cannot jump like the O-rings 12 in FIGS. 1 to 3. However, forces are produced according to FIG. 6 during the insertion of the anchor piece 17 into the recess 2, when the annular rings 19 in the inserted condition of the anchor piece 17 are not directly opposite the annular grooves 5. If the annular grooves 5 are at a somewhat lower level, the deformation auf the annular rings 19 formed of elastic material effects a reaction force in the direction of a prestress between anchor piece 17 or flange 20 and bearing surface 21. The forces decisive for the self-stressing property can be adjusted by selecting the dimensions, in particular the diameters of the O-rings which may be different, and the offset of the annular grooves from each other and by the elasticity of the components (anchor piece 17, O-rings 12, insertion piece 3).

A fastening device for the non-positive positioning of an anchor piece formed with a depth stop such as a flange or yoke in a recess or on an insertion piece located in the recess, comprising at least one O-ring in an open annular groove or at least one annular ring on the one hand and at least one recess, e.g. in the form of an annular groove, for receiving the O-ring or annular ring on the other in either the curved surface of the anchor piece or the curved surface of the recess, characterised in that the curved surfaces (4, 10, 18) are conical surfaces whose cone angles are in substantial agreement and the annular groove (5) with which an opposite O-ring (12) or annular ring (19) engages is located at a lower level in the axial direction than the O-ring (12) or annular ring (19) of the anchor piece (7, 17) resting on the stop, e.g. the flange (9, 30).

The fastening device according to claim 1, wherein adjacent open concentric annular grooves (5) are provided on the curved surfaces (4, 10, 18) of the anchor piece (7, 17) and in the recess (2) which, when the anchor piece (7, 17) has been inserted into the recess (2) until it reaches the stop, are opposite to each other in such a way that they are axially offset from each other and are adjacent to each other with a clearance, the O-rings (12) or annular rings (19) penetrating into the diagonally opposite annular grooves (5), while being elastically deformed, and releasing a force component (14) in the sense of a pressure against the stop.

The fastening device according to claim 2, wherein the radii of the channels of the annular grooves (15, 11) of the anchor piece (7, 17) increase for respectively larger annular groove diameters from annular groove (5, 11) to annular groove (5, 11) and the O-rings (12) also comprise increasingly larger circular cross-sections.

The fastening device according to claim 1 or 2, wherein the anchor piece (7) carries an O-ring (12) in each of the open annular grooves (11) provided in the conical curved surface of the anchor piece (7), except for the annular groove having the largest diameter, and that ribs (6) protruding in the recess (2) between the open annular grooves (5) engage between the O-rings (12) of the anchor piece (7) and, when the anchor piece (7) is pressed in, force the O-rings (12) into the annular groove (11) having the respectively next larger diameter, in which position they non-positively and positively engage with the annular grooves (5) of the recess (2) which are arranged at a respectively slightly lower level.

1. A fastening device for the non-positive positioning of an anchor piece formed with a depth stop such as a flange or yoke in a recess or on an insertion piece located in the recess, comprising at least one O-ring in an open annular groove or at least one annular ring on the one hand and at least one recess, e.g. in the form of an annular groove, for receiving the O-ring or annular ring on the other in either the curved surface of the anchor piece or the curved surface of the recess characterized in that the curved surfaces (4, 10, 18) are conical surfaces whose cone angles are in substantial agreement and the annular groove (5) with which an opposite O-ring (12) or annular ring (19) engages is located at a lower level in the axial direction then the O-ring (12) or annular ring (19) of the anchor piece (7, 17) resting on the stop, e.g. the flange (9, 30).

2. The fastening device according to claim 1, wherein the adjacent open concentric annular grooves (5) are provided on the curved surfaces (4, 10, 18) of the anchor piece (7, 17) and in the recess (2) which, when the anchor piece (7, 17) has been inserted into the recess (2) until it reaches the stop, are opposite to each other in such a way that they are axially offset from each other and are adjacent to each other with a clearance, the O-rings (12) or annular rings (19) penetrating into the diagonally opposite annular grooves (5), while being elastically deformed, and releasing a force component (14) in the sense of a pressure against the stop.

3. The fastening device according to claim 2, wherein the radii of the channels of the annular grooves (15, 11) of the anchor piece (7, 17) increase for respectively larger annular groove diameters from annular groove (5, 11) to annular groove (5, 11) and the O-rings (12) also comprise increasingly larger circular cross-sections.

4. The fastening device according to claim 1, wherein the anchor piece (7) carries an O-ring (12) in each of the open annular grooves (11) provided in the conical curved surface of the anchor piece (7), except of the annular groove having the largest diameter, and that ribs (6) protruding in the recess (2) between the open annular grooves (5) engage between the O-rings (12) of the anchor piece (7) and, when the anchor piece (7) is pressed in, force the O-rings (12) into the annular groove (11) having the respectively next larger diameter, in which position they non-positively and positively engage with the annular grooves (5) of the recess (2) which are arranged at a respectively slightly lower level.

5. The fastening device according to claim 2, wherein the anchor piece (7) carries an O-ring (12) in each of the open annular grooves (11) provided in the conical curved surface of the anchor piece (7), except of the annular groove having the largest diameter, and that ribs (6) protruding in the recess (2) between the open annular grooves (5) engage between the O-rings (12) of the anchor piece (7) and, when the anchor piece (7) is pressed in, force the O-rings (12) into the annular groove (11) having the respectively next larger diameter, in which position they non-positively and positively engage with the annular grooves (5) of the recess (2) which are arranged at a respectively slightly lower level.
